(19) United States
(12) Patent Application Publication
(10) Pub. No.: US 2023/0382742 A1
(43) Pub. Date: Nov. 30, 2023

(54) PROCESS FOR THE CONTROLLED DECOMPOSITION OF PEROXO COMPOUNDS

(71) Applicant: BASF SE, Ludwigshafen am Rhein (DE)

(72) Inventors: Andreas KEMPTER, Ludwigshafen (DE); Frank PIEPENBREIER, Ludwigshafen (DE); Frieder BORGMEIER, Ludwigshafen (DE)

(21) Appl. No.: 18/266,521

(22) PCT Filed: Dec. 2, 2021
(86) PCT No.: PCT/EP2021/084020

§ 371 Date: Jun. 9, 2023

(30) Foreign Application Priority Data
Dec. 10, 2020 (EP) 20212963.1

(51) Int. Cl. C01B 32/50; C01B 32/40

(52) U.S. Cl. CPC C01B 32/50; C01B 32/40

(57) ABSTRACT

The present invention relates to a method for the decomposition, removal or destruction of at least one peroxo compound, the use of an alkane and sulfur trioxide for decomposing peroxo compounds, and a method for manufacturing CO and/or CO₂ from a peroxo compound.

The present invention relates to a method for manufacturing CO and/or CO₂ from a peroxo compound and to a method for the controlled decomposition, removal or destruction of peroxo compounds, especially inorganic peroxo compounds comprising peroxides containing sulfur, phosphorpous, nitrogen, boron and/or hydrogen peroxide, wherein a peroxo compound is reacted with an alkane, especially methane and SO₃ in a way that CO₂ and/or CO are formed as the main decomposition products (instead of oxygen).

The present invention furthermore relates to the use of an alkane, especially methane, and the use of sulfur trioxide in the decomposition of peroxo compounds, especially peroxo compounds containing sulfur, phosphorpous, nitrogen, boron and/or hydrogen peroxide or mixtures thereof.

The present invention also relates to a method for manufacturing CO₂ and/or CO from peroxo compounds.

Peroxo Compounds (General)

Peroxides or peroxo compounds of the general type R—OO—R, are widely used e.g. as catalysts for chemical reactions or as cleaning agents in e.g. water treatment. According to Ullmanns encyclopedia of industrial chemistry, (DOI 10.1002/14356007.a19_177.pub2), Peroxo compounds include hydrogen peroxide and substances derived from hydrogen peroxide by substitution of one or both hydrogen atoms by a metal or a nonmetal such as sulfur, boron, nitrogen, or phosphorous. Also hyperoxides (MO2, with M being e. g. Na, K, Li, . . . ), H₂O₂ adduct compounds (e.g., sodium carbonate peroxohydrate), and the inorganic ozonides (MIO3, with M being e. g. Na, K, Li, . . . ) are summarized under this term. (Whereas the prefix peroxo is, according to the IUPAC nomenclature, used for inorganic compounds, the prefix peroxy is used for organic compounds. In this text, the terms “peroxo” and “peroxy” are used synonymously.)

The O—O bonding strength in peroxo compounds is rather low (˜209 kJ/mol), so all peroxo compounds can be regarded as powerful oxidation agents with strong oxidizing properties. This is due to the fact that the oxygen atom in the peroxo compounds is present in the unstable +1 oxidation state. However, depending on the co-reactant, reaction conditions and solvent (protic, aprotic, acidic, superacidic) peroxo compounds, especially Hydrogen peroxide can react as both oxidizing and in rare cases reducting agent (one example of the latter is described in Muruganandham, M. et al. Int. J. Photoenergy 2014, 2014, 1-21).

Peroxo compounds, especially Hydrogen peroxide can react as both oxidizing and reducing agent.

A main feature of those compounds is the ready decomposition under the formation of radicals, as a result of the homolytic cleavage of the O—O bond. This decomposition can be initiated either thermally or catalytically, e.g. with the help of metal ions, or by irradiation. This behavior is one of the wanted features for e.g. catalytic reactions like organic polymerizations, in which these compounds accelerate the reaction. The exothermic redox disproportionation (scheme 1) however often is a problem when using peroxo compounds, yielding active oxygen as the decomposition product.

H₂O₂→H₂O+½O₂

Therefore, in commercially available peroxo compounds including hydrogen peroxide, decomposition, especially the exothermic redox disproportionation upon storage, is usually suppressed or considerably reduced by the addition of small quantities of stabilizers.

Besides the high reactivity of peroxo compounds, especially in organic reactions, the presence of oxygen can cause severe safety concerns, as explosive atmospheres can be generated if peroxo compound decomposition to oxygen occur.

The hydrolyzation of peroxo compounds containing sulfur, boron, nitrogen or phosphorous in e.g. aqueous solutions usually give hydrogen peroxide as the hydrolysis product.

The term peroxo compounds according to the present invention comprises inorganic peroxoacids and salts thereof. These peroxoacids comprise peroxoacids of boron, silicon, phosphorus, sulfur, nitrogen or carbon. The peroxoacids may be obtained from a reaction of an oxoacid or a salt thereof with a peroxide, especially hydrogen peroxide. Specific examples comprise the reaction product of phosphoric acid with hydrogen peroxide, the reaction product of boric acid with hydrogen peroxide and/or potassium peroxomonosulfate. Suitable organic peroxyacids comprise peroxosulfonic acids, peroxoalkanesulfonic acids, peroxybenzoic acid and trifluoroperacetic acid.

In place of the free oxoacids or peroxoacids, salts thereof may also be employed in the present inventive process.

Peroxo Compounds Containing Sulfur

Peroxomonosulfuric acid (H₂SO₅), also known as persulfuric acid, peroxysulfuric acid, or Caro's acid (named after HEINRICH CARO (1834-1910) who first described its synthesis and properties in 1898), and also its salts (sodium, potassium, ammonium, cesium, lithium, and rubidium salts, especially the triple salt KHSO5 KHSO4 K2SO4) is known and used with commercial relevance. Whereas Caro's acid, a strong acid, in solution loses active oxygen much faster than hydrogen peroxide solutions, in its salts, especially the triple salt, the loss of active oxygen under proper storage conditions is below 1% per month.

The synthesis of peroxomonosulfuric acid usually involves the addition of H₂O₂ to H₂SO₄ according to

H₂O₂+H₂SO₄⇄H₂SO₅+H₂O

With an equilibrium constant of 0.1.

Peroxodisulfuric acid, also known as Marshall's acid, HO₃SOOSO₃H, can be formed similarly using chlorosulfuric acid and H₂O₂. Other synthesis routes involve anodic oxidation of sulfuric acid followed by hydrolysis or the reaction of Caro's acid with SO₃. The hydrolysis to sulfuric acid and peroxomonosulfuric acid is irreversible, whereas the further hydrolysis of peroxomonosulfuric acid is reversible.

H₂S₂O₈+H₂O→H₂SO₄+H₂S₅

H₂SO₅+H₂O⇄H₂SO₄+H₂O₂

While Peroxodisulfuric acid is not used commercially, its salts, the peroxodisulfates, especially the ammonium, potassium and sodium salts are widely used.

Peroxodisulfates are e.g. used as radical initiators in emulsion polymerization processes for the manufacture of acrylonitrile-butadiene-styrene copolymers (ABS), high-impact polystyrene (HIPS), and styrene-acrylonitrile (SAN).

Monomethylsulfonyl Peroxide and Dimethylsulfonyl Peroxide:

Similar peroxospezies can be derived, if instead of sulfuric acid methanesulfuric acid is used. The so formed Monomethylsulfonyl peroxide, H₃C—SO₂OOH and dimethylsulfonyl peroxide, H₃C—SO₂—OO—SO₂CH₃, in their acid or salt form are accessible, wich can also be used as e.g. radical initiators in chemical reactions. Furthermore, electrochemical synthesis is described for these compounds, e.g. in WO15071371.

Other peroxo compounds, wich can be used according to the present invention, are for example summarized in Ullmann's Encyclopedia of industrial chemistry in the chapter “Peroxo Compounds, Inorganic” (Wiley-VCH Verlag, 2012, p. 293-319; DOI 10.1002/14356007.a19_177.pub2) and include inorganic peroxides, hyperoxides and ozonides of alkali and alkaline earth metals, peroxoborates, perborates, peroxophosphoric acids, sodium carbonate peroxohydrate, hydrogen peroxide addition compounds and derivatives, but are not limited to this.

The amount of peroxo compound used according to the present invention can be referred to as “H₂O₂ equivalent”. The term H₂O₂ equivalent is the amount of hydrogen peroxide (in e.g. grams), which has the same number or amount of “O—O” bonds compared to the peroxo compound. The following example will illustrate but not limit this:

114 g Caro's acid=1 mol Caro's acid=1 mol “O—O” bonds, which means, 114 g Caro's acid equals 1 mol H₂O₂=34 g. So, if a reaction is performed with 2 wt % H₂O₂ equivalent, this means, that either 2 g H₂O₂ (0.0588 mol) can be used or 6.7 g Caro's acid (0.0588 mol) or 11.2 g Marshall's acid (=0.0588 mol) and so forth, depending on the molecular weight of the peroxo compound applied in the method according to the present invention.

H₂O₂, as well as peroxo compounds in general, is very important for a variety of reactions in both inorganic and organic chemistry, e.g. epoxidation and hydroxylation, oxidation, oxohalogenation and initiation of polymerization.

As mentioned above, exothermic redox disproportionation of peroxo compounds can yield active oxygen. This may be problematic, as mixtures with combustible materials are easily ignited and burn vigorously even in the absence of externally provided oxygen. If organic material is used, a mixture with hydrogen peroxide gives the risk of an explosive atmosphere, once decomposition to oxygen occurs. Also, unwanted side products or unreacted peroxo compounds can cause severe problems in the following process steps, which requires large efforts for the further processing of the reaction products e.g. in a distillation step, a crystallization step or further purification steps or other work-up steps.

One example is the so called HPPO process, in which propylene is treated with H₂O₂ to form propylene oxide.

WO 02/062779 describes a process for the epoxidation of an organic compound using hydrogen peroxide. In this process, peroxo compounds (alpha-hydroperoxyalcohols) are formed as side products. It is claimed that this side product is reduced with a reducing agent to minimize/get rid of post treatment efforts.

In principle, in every process in which peroxo compounds are used, e.g. in chemical synthesis, residual peroxo compounds or peroxo compounds formed during the process can be present after the process and prior to any post processing or purification step. Especially if the post processing step is accompanied by a heat treatment step, e.g. a distillation step. The thermally induced decomposition in the preheating or heating prior or in e.g. the distillation might cause decomposition of the peroxo compound. The formation of either unwanted side components or active oxygen, which, depending on the process parameters, can yield an explosive atmosphere. This may lead to severe safety issues, when the oxygen created from decomposition of a peroxide is ignited, for example by the heat of reaction and/or post treatment steps, or by other ignition source, e. g. process equipment like motors or electrostatic charging.

Thus, peroxo compounds must usually be removed, decomposed or destroyed prior to further processing, e.g. distillation or other post treatment. The phrase remove, decompose or destroy describes a process, at the end of which no or significantly lower amounts of peroxo compounds (incl. hydrogen peroxide) are present in the solution.

Additionally, peroxo compounds, due to their tendency for spontaneous decomposition, should be destroyed, removed or controlledly decomposed also if no immediate further use is intended, to prevent unwanted decomposition reactions e.g. upon storage.

Several processes are known in the prior art to remove, decompose and or destroy peroxo compounds, mainly hydrogen peroxide, in aqueous solutions.

WO 2018/123156 describes a method and apparatus for the removal of hydrogen peroxide from water by the use of a platinum type catalyst. No information is given about the composition of the decomposition products.

WO 91/12826 claims a composition comprising at least one hydrogen peroxide destroying component effective when released in aqueous media. The hydrogen peroxide destroying component is selected from the group of hydrogen peroxide reducing agents, peroxidases and mixtures thereof. Water is mandatory as the hydrogen peroxide destroying component is effective only when released into liquid aqueous medium.

Reduction of hydrogen peroxide in waste water using a dissolved iron compound is described in WO2017/210094.

Other ways for controlled decomposition of peroxo compounds involve the use of reducing agents, e.g. iron (II) sulfate or sodium bisulfate. Alternatively, inorganic peroxo compounds can be treated with acidic sodium thiosulfate solution. It is recommended to dilute pure peroxides or concentrated solutions prior to disposal or reaction with a reducing agent. If decomposition according to these methods is performed, respective Iron (Ill) compounds and sulfate via oxidation of thiosulfate are formed.

No solution so far was reported for the controlled decomposition of a peroxo compound in highly acidic media without the need for dilution of the respective acid solution with water.

The term “controlled decomposition”, according to the present invention, relates to a method, in which a peroxo compound is decomposed in a way, that no runaway reaction occurs and the decomposition is controlled in a way, that the temperature during decomposition can be controlled with state of the art methods. Furthermore, the term controlled decomposition, in the sense of the present invention, may also refer to a process wherein the kind and amount of products can be controlled.

Additionally, removal of peroxo compounds in highly acidic media occurs, according to the inventive process, entirely without, or with significantly reduced formation of any unwanted and for the further processing disturbing side products like products derived from the aforementioned reducing agents (iron (Ill) compounds etc.) or especially oxygen. Instead, CO and/or CO₂ as the main decomposition products are formed, according to the inventive method.

It is thus one object of the invention to provide a method for the removal, decomposition or destruction of peroxo compounds, including but not limited to inorganic peroxo compounds comprising peroxides containing sulfur, phosphorpous, nitrogen, boron and/or hydrogen peroxide in highly acidic media without the need for diluting the acidic media with water or other solvents in a way to form CO and/or CO₂, and the formation of oxygen during the removal, decomposition or destruction of peroxo compounds is prevented or significantly reduced.

Decomposition, removal or destruction of the peroxo compound in the sense of the present invention particularly refers to the reduction of the amount of the peroxo compound from a solution containing higher amounts of said peroxo compounds prior to treatment of this solution in a way described in this invention. Particularly, a method for the removal, decomposition or decomposition of peroxo compounds without the formation of disturbing side products will be provided.

Furthermore, a method for the decomposition, destruction and removal of peroxo compounds without or with significantly reduced formation of oxygen is provided.

One subject of the present invention is a method for the decomposition, removal or destruction of at least one peroxo compound, wherein a peroxo compound, especially a peroxo compound comprising sulfur, phosphor, nitrogen, boron and/or hydrogen peroxide, is contacted, preferably in acidic medium, preferably free of water, with an alkane, especially methane, and SO₃.

Preferably, the formation of oxygen is prevented almost entirely or at least considerably reduced in the present process.

“Free of water”, in the context of this invention, means less than 3% by weight water, preferably less than 1% by weight water, more preferably less than 0.5% by weight water.

Further subjects of the present invention are also the use of an alkane, preferably methane, and sulfur trioxide for decomposing peroxo compounds, preferably a peroxo compound comprising sulfur, phosphor, nitrogen, boron and/or hydrogen peroxide, and a method for manufacturing CO₂ and/or CO from a peroxo compound, wherein a peroxo compound, preferably a peroxo compound comprising sulfur, phosphor, nitrogen, boron and/or hydrogen peroxide, is contacted with an alkane, preferably methane, and SO₃.

The present invention is thus, in one aspect, directed at a method for manufacturing CO₂ and/or CO from a peroxo compound, wherein a peroxo compound, preferably a peroxo compound comprising sulfur, phosphor, nitrogen, boron and/or hydrogen peroxide, is contacted with an alkane, preferably methane, and SO₃.

The present invention, in a preferred embodiment, also comprises a method for manufacturing CO₂ and/or CO as described above, wherein the amount of peroxo compound used is in the range from 0.1 to 4.0 wt % H₂O₂ equivalent, and/or wherein the method is performed at a temperature of from 25° C. to 100° C., and/or wherein the method is performed at a pressure of from 10 to 200 bar, and/or at a temperature of from 25° C. to 100° C., preferably 40° C. to 80° C., more preferred 45° C. to 65° C.

Whereas decomposition of the peroxo compound in the absence of either SO₃ or methane, or in the absence of both, always gives oxygen as (main) decomposition product we surprisingly found that the (main) decomposition product(s) of the peroxo compounds using the method of the present invention are CO₂ and CO and/or a mixture thereof instead of oxygen.

The formed CO₂ inherently reduces the risk to release active oxygen (i. e. oxygen which easily reacts with other compounds, for example organic compounds), also upon destruction, decomposition or removal of the peroxo compound, and consequently allows to reduce other safety measures normally required when using peroxo compounds.

According to the present invention, the use of dedicated reducing agents like iron (II) compounds or thiosulfates or bisulfate for the removal of peroxo compounds may be avoided.

In a first embodiment, the invention provides a method for removal, decomposition or destruction of peroxo compounds, wherein the peroxo compound, especially a peroxo compound containing sulfur, is contacted with an alkane, especially methane, and SO3 in a solvent comprising sulfuric acid, alkanesulfonic acid, especially methanesulfonic acid, oleum (mixture of sulfuric acid and SO₃), SO₃ or mixtures of two, three or more of these compounds. The inventive solvent may additionally comprise a compound selected from the list consisting of pyro sulfuric acid, pyro alkanesulfonic acid, methanedisulfonic acid, traces of metals, and mixtures thereof.

In a preferred embodiment, the peroxo compound is selected from the list consisting of Caro's acid, Marshall's acid, monomethylperoxodisulfate, dimethylperoxodisulfate, hydrogen peroxide and mixtures thereof.

In another preferred embodiment, the peroxo compound is synthesized by contacting sulfuric acid with hydrogen peroxide, methanesulfonic acid with hydrogen peroxide or a mixture of sulfuric acid and methanesulfonic acid with hydrogen peroxide and optionally sulfur trioxide. It is preferred that this step is done at temperatures below room temperature, more preferably at temperatures between −5 and 20° C., even more preferably between 5 and 15° C.

If a mixture of sulfuric acid and methanesulfonic acid is used, one preferred embodiment of the present inventive process is the use of a mixture with a ratio of methanesulfonic acid to sulfuric acid of at least 10:90 (w/w). More preferred is a ratio of methanesulfonic acid to sulfuric acid ranging from 20:80 (w/w) to 40:60 (w/w).

Preferably, the temperature in the manufacturing of the peroxo compound is, according to the inventive process, in the range from −5° C. to 45° C., preferably −5° C. to +20° C., more preferably in the range from −2° C. to +15° C. and most preferably in the range from 0° C. to 10° C., or any value between these values or ranges thereof.

The pressure in the manufacturing of the peroxo compound, according to the inventive process, can be any pressure, preferably a pressure close to normal conditions or for example slightly increased pressures, in particular in the range from 0.5 bar to 10 bar, more preferably in the range from 0.8 bar to 5 bar and most preferably at about 1013 mbar or for example at slightly elevated pressure beyond 1013 mbar e.g. 2 bar (absolute), or any value between these values or ranges thereof.

The peroxo compound is, according to the present invention, preferably dissolved in an acid. Particularly, the peroxo compound is dissolved in sulfuric acid, alkanesulfonic acid, especially methanesulfonic acid, SO₃ or a mixture thereof.

The method is preferably performed in a high-pressure-reactor and particularly the reactor is pressurized with methane gas.

The process can be set up in a batch mode or in a continuous mode. It is preferred to operate the process in continuous mode.

The method of the present invention comprises, in one embodiment, the following steps:
1) Providing a solution comprising SO₃ and an acid in a reactor
2) Heating the mixture of 1) to a temperature >30° C.
3) Providing an alkane, preferably methane, at a pressure higher than ambient pressure
4) Providing the peroxo compound, either in pure form or as a solution,
5) Reaction of the peroxo compound with SO₃ and the alkane, preferably methane, in a way that the main decomposition product is CO₂ and/or CO or mixtures thereof
6) Removing the reaction product from the reaction vessel
7) Optionally removing residual methane and CO₂ and/or CO by a degassing step
8) Operating steps 1-7 in a continuous way, preferably by supplying the raw materials as listed under 1), 3) and 4) continuously to the reactor to maintain the concentrations/stochiometries at a constant level within a range of plus/minus 5% and/or to keep temperature and pressure at a constant level within a range of plus/minus 5%.

In another embodiment, the alkane is methane and the inventive method comprises the following steps:
1) Providing a solution comprising SO₃, sulfuric acid and methanesulfonic acid in a reaction vessel
2) Heating the mixture of 1) to a temperature higher than 40° C.
3) Applying an alkane, preferably methane, at a pressure of 80 bar to 120 bar,
4) Providing a peroxo compound in a solution comprising sulfuric acid and methanesulfonic acid,
5) Reacting the peroxo compound with SO₃ and the methane, resulting in CO₂ and/or CO as the main decomposition product(s),
6) Removing the reaction product from the reaction vessel,
7) Optionally removing residual methane and CO₂ and/or CO by a degassing step
8) Operating steps 1-7 in a continuous way, preferably by supplying the raw materials as listed under 1), 3) and 4) continuously to the reactor, preferably to maintain the concentrations/stochiometries at a constant level within a range of plus/minus 5% and/or to keep temperature and pressure at a constant level within a range of plus/minus 5%.

In general, in the inventive process, the peroxo compound is contacted with an alkane, especially methane, in the presence of sulfur trioxide.

The inventive method is preferably performed at a pressure of from 10 to 200 bar, more preferably 30 to 150 bar, particularly 50 to 110, especially at a pressure of 70 to 100 bar.

The inventive method is preferably performed at a temperature of from 25° C. to 100° C., more preferably 40° C. to 80° C., most preferably 45° C. to 65° C.

If the temperature is not precisely controlled, i.e. within a range of +/−5° C. relative to the target temperature, more preferably within a range of +/−3° C., most preferably within a range of +/−1° C., the decomposition/removal or destruction of the peroxo compound does not only give CO₂ and/or CO, but also significant amounts of oxygen can be formed.

The target temperature may be chosen, depending on the specific reactor design and process setup, within the above temperature ranges, i. e. preferably between 25° C. to 100° C. The target temperature, in one embodiment of the inventive method, lies within 45° C. to 65° C., preferably 45° C. to 60° C. The target temperature may be around 50° C. or around 55° C., in one embodiment of the inventive method.

In a preferred embodiment of the invention, the peroxo compound may be reacted with the alkane, especially methane, and SO₃ for a particular period of time in a reactor operated in batch mode or a continuously operated reactor. The reaction time is preferably in a range of from 5 minutes to 3 days, more preferably from 20 minutes to 24 hours, particularly 1 hour to 8 hours.

A longer reaction time generally leads to a higher reduction (or complete decomposition) of the amount of peroxo compound.

In another preferred embodiment of the invention, the peroxo compound, referred to as “H₂O₂ equivalents”, may be reacted with the alkane, especially methane, and SO₃ in a solution comprising sulfuric acid and alkanesulfonic acid, especially methanesulfonic acid, with 0.1 to 4 wt % of H₂O₂ equivalents, preferably 0.5 to 3 wt % of H₂O₂ equivalents, more preferably 0.6-2 wt % of H₂O₂ equivalents, most preferred with 0.8 to 1.8 wt % of H₂O₂ equivalents.

Surprisingly, it has been found that the peroxo compounds employed in the aforementioned processes according to the method of the present invention are decomposed to form significant amounts of CO₂ and/or CO or mixtures thereof, instead of active oxygen.

In general, the decomposition of the peroxo compound to form oxygen cannot be excluded completely in the inventive process, thus also traces or small amounts of oxygen may also be present when the method according to the present invention is applied (see e.g. comparative examples).

In one embodiment of the inventive process, less than 5 vol.-% of oxygen are formed (based on the mixture at the end of the inventive process), preferably less than 3 vol.-%, more preferably less than 1 vol.-% and even more preferably less than 0.5 vol.-%.

Depending on the reaction pathway, several intermediates can be formed during the decomposition, removal or destruction of the peroxo compound. In the case of methane as the alkane, the compound methylbisulfate may be one of the intermediates. Surprisingly, this compound can be detected, e.g. by means of e.g. NMR spectroscopic analysis in the reaction mixture in traces if the method according to the present invention is applied.

Additionally, as the decomposition, destruction or removal of the peroxo compound is believed to optionally appear as radical reactions, other side products are possible. These possible side products are e.g. described in WO 2018/219726 and are e.g. the methylester of methanesulfonic acid (MeMSA), methylenedisulfocin acid (MDSA). Other side products are possible. Additionally, the dehydratisation of methanol, potentially formed from the aforementioned side product, gives CO as additional or only decomposition product. Thus, in an alternative embodiment of the present invention, besides CO₂ as the main decomposition product, also other decomposition products of the peroxo compounds are possible including, but not limited to, CO, MeMSA, MDSA, MBS and mixtures thereof.

Thus, in one embodiment of the present invention, the decomposition, destruction or removal of peroxo compounds according to the present invention liberates CO₂ and/or CO and/or a mixture thereof as the main decomposition product(s).

Sulfur trioxide may be used, for example, in the form of oleum with a trioxide content of up to ca. 70% (w/w). It has been found that also oleum with a sulfur trioxide content of 65% (w/w) or more, also of 70% w/w or more can be used in the inventive process. Even pure sulfur trioxide (100% (w/w) sulfur trioxide) may be used.

Sulfur trioxide is preferably employed at least in a stoichiometric amount with respect to the peroxo compound to be removed. More preferably, sulfur trioxide is employed in a stoichiometric excess with respect to said peroxo compounds. The molar ratio between sulfur trioxide and the peroxo compound is particularly in a range of from 30:1 to 1:1, preferably 25:1 to 10:1.

Suitable peroxo compounds comprise inorganic or organic peroxoacids, which are stable at room temperature. Suitable inorganic peroxoacids comprise peroxoacids of boron, silicon, phosphorus, sulfur, nitrogen or carbon. The peroxoacids may be obtainable from a reaction of an inorganic oxoacid or a salt thereof with a peroxide, especially hydrogen peroxide. Specific examples comprise the reaction product of phosphoric acid with hydrogen peroxide, the reaction product of boric acid with hydrogen peroxide and/or potassium peroxomonosulfate. Suitable organic peroxoacids comprise peroxoalkanesulfonic acids, peroxybenzoic acid and trifluoroperacetic acid.

In place of the free oxoacids or peroxoacids, salts thereof may also be employed.

The aforementioned peroxo compounds may be reacted with sulfur trioxide and an alkane in order to be decomposed, removed or destroyed in the sense of the present invention.

More examples are described in the aforementioned prior art documents incorporated herein by reference. Every initiator suitable to be employed in the aforementioned methods of the prior art for the production of alkanesulfonic acids from alkanes and sulfur trioxide may be employed in the method of the present invention as peroxo compound and decomposed, removed or destroyed according to the present invention.

The inventive method may be carried out in continuous or batch mode of operation. It can be carried out in one or more batch reactors. Furthermore, the inventive method may be carried out in one or more continuous reactors. Suitable reactors are e.g. continuously stirred tank reactor, air lift reactor, a bubble column or a trickle bed reactor or a pipe reactor

Suitable reactors are also one or several stirred tank reactors, bubble column reactors, gas circulation reactors, air lift reactors, jet loop reactors, falling film reactors, tubular reactors, trickle bed reactors. For heating or cooling the solution, coils and pipes inside the reactor can be used. Furthermore, the reactor can be heated or cooled via the reactor surface e.g. with a double jacket or a half pipe coil. In another option the temperature in the reactor can be adjusted by a loop with an external heat exchanger (e.g. tube bundle, u-tube, block, plate heat exchanger). For mixing the solution either a stirrer or a loop with a pump can be used.

For the release of CO and CO₂ a large surface area for liquid-to-gas mass transport should be provided. This can, for example, be achieved by the dispersion of the liquid into small droplet (e.g. with a stirrer or with a nozzle) or with a fast liquid jet hitting a liquid surface. Another option is the use of equipment having a large surface area like a fixed bed, Raschig Rings, structured packings and likewise.

The method according to the present invention can be performed either in one or a series of reactors, where the peroxo compound is added either in the first reactor only or the addition is divided into the first and one or more of the following reactors.

In one embodiment, the inventive method comprises the following steps:
i) Providing a solvent comprising an inorganic acid, preferably an inorganic acid selected from sulfuric acid, methanesulfonic acid or mixtures thereof,
ii) Providing an alkane, preferably methane,
iii) providing the peroxo compound;
iv) providing sulfur trioxide,
v) setting a pressure of from 1 to 200 bar and controlling it within this range;
vi) setting the temperature of the reaction mixture at 0° to 100° C. and controlling it within this range;
vii) providing a peroxo compound,
viii) reacting the peroxo compound with the alkane, especially methane, and SO₃, for example in a high-pressure autoclave or a laboratory reactor;
ix) optionally repeating steps i) to viii) to remove, decompose or destroy the peroxo compound under the formation of CO₂ and/or CO and mixtures thereof.

The sequence of the steps can be altered or combined. Preferably, the addition of SO₃ is done earlier than the addition of the peroxo compound. For example step 3 can be done prior to step 2. And/or step 5 can be done right after providing the solvent (step 1). And/or steps 2 and 4 can be combined.

The inventive method for the decomposition, removal and destruction of peroxo compounds, is characterized, in one embodiment, by the use of methane and SO₃ for the decomposition, removal or destruction of peroxo compounds, especially peroxo compounds containing sulfur and/or hydrogen peroxide or mixtures thereof.

The following examples serve to illustrate some aspects of the present invention.

### EXAMPLES

The examples were performed in a 270 ml stainless steel autoclave. It has to be noted, that the gas composition analyzed depends on the reactor size and the volume of the gas phase in the autoclave. Thus, if other equipment or different amounts of solvents are used, different vol % may be detected for the analyzed species.

### Comparative Example 1

In a 270 ml autoclave, a mixture consisting of 29.62 g methanesulfonic acid and 70.25 g concentrated sulfuric acid is charged, and the temperature controlled to 65° C. After a N2 gas pressure of 99.7 bar is set, 3.4 ml of H₂O₂ (70% in water) is metered dropwise to the solution under intensive stirring with a Rhuston turbine stirrer, The reaction is kept at this temperature and pressure for 19 h. The reactor was then cooled down to room temperature. The gas phase after the reaction was collected and analysed by GC-MS. A total of 5.61 vol % oxygen, below 0.03 vol % CO and 0.08 vol % CO2 was detected. Thus, main decomposition product was oxygen.

### Comparative Example 2

In a 270 ml autoclave, a mixture consisting of 30.12 g methanesulfonic acid and 70.10 g concentrated sulfuric acid is charged, and the temperature controlled to 65° C. After a pressure of −100 bar of methane gas was set, intensive stirring is performed with a Rhuston turbine stirrer and the pressure controlled throughout the reaction. Now, 3.45 ml of H₂O₂ (70% in water) is metered dropwise to the solution. The reaction kept at 65° C. and for 19 h at 100.6 bar. The reactor was then cooled down to room temperature.

The gas phase after the reaction was collected and analysed by GC-MS. A total of 5.53 vol % oxygen, below 0.03 vol % CO and 0.05 vol % CO2 was detected. Thus, main decomposition product was oxygen.

### Comparative Example 3

In a 270 ml autoclave, a mixture consisting of 16.88 g methanesulfonic acid and 40.12 g concentrated sulfuric acid is charged, and the temperature controlled to 65° C. After a pressure of ˜100 bar of methane gas was set, intensive stirring is performed with a Rhuston turbine stirrer and the pressure controlled throughout the reaction. Now, a mixture, prepared by slowly adding 3.45 ml of H₂O₂ (70% in water) to a mixture consisting of 30.68 g concentrated sulfuric acid and 13.10 g methanesulfonic acid) is metered dropwise to the solution. The reaction kept at 65° C. and at 100.6 bar for 19 h. The reactor was then cooled down to room temperature.

The gas phase after the reaction was collected and analysed by GC-MS. A total of 5.54 vol % oxygen, below 0.03 vol % 0 and 0.05 vol % CO2 was detected. Thus, main decomposition product was oxygen.

### Comparative Example 4

The experiment was performed similar to comparative example 1 using 29.96 g methanesulfonic acid and 69.74 g concentrated sulfuric acid and 1.8 ml of H₂O₂ (70% in water) at a temperature of 50° C. and 99 bar N2 pressure. The reaction was kept under these conditions for 18.5 h. The reactor was then cooled down to room temperature. The gas phase after the reaction was collected and analysed by GC-MS. A total of 2.9 vol % oxygen, below 0.03 vol % CO and 0.07 vol % CO2 was detected. Thus, main decomposition product was oxygen.

### Comparative Example 5

The experiment was performed similar to comparative example 2 using 30.46 g methanesulfonic acid and 72.24 g concentrated sulfuric acid and 1.85 ml of H₂O₂ (70% in water) at a temperature of 50° C. and 99 bar CH₄ pressure. The reaction was kept under these conditions for 20 h. The reactor was then cooled down to room temperature. The gas phase after the reaction was collected and analysed by GC-MS. A total of 3.05 vol % oxygen, below 0.03 vol % CO and 0.05 vol % CO2 was detected. Thus, main decomposition product was oxygen.

### Example 1

In a 300 ml autoclave, a mixture of 33.47 methanesulfonic acid, 7.10 g concentrated sulfuric acid and 61.74 g Oleum 32 (32% SO3 in H2SO4) is charged, and the temperature controlled to 65° C. After a constant pressure of 101.4 bar of methane gas was set, intensive stirring is performed with a Rhuston turbine stirrer, and 3.4 ml of H₂O₂ (70% in water) is metered dropwise to the solution. The reaction kept at this temperature for 19.5 h. The reactor was then cooled down to room temperature.

The gas phase after the reaction was collected and analysed by GC-MS.

A total of ˜2.7 vol % CO2 and only traces of oxygen and CO were detected. Thus, main decomposition product was carbon dioxide.

### Example 2

The experiment was performed similar to example 1, however a solution containing 33.49 g methansulfonic acid, 7.06 g concentrated sulfuric acid and 62.57 g Oleum 32 (32 wt % SO3 in sulfuric acid) with 3.45 ml H₂O₂ (70% in water) was used. The reaction was performed at a temperature of 50° C. and a methane pressure of 99 bar.

The gas phase after the reaction was collected and analysed by GC-MS. A total of ˜2.6 vol % CO2 and only traces of oxygen and CO were detected. Thus, main decomposition product was carbon dioxide.

### Example 3

The experiment was performed similar to example 1, but 33.97 methanesulfonic acid, 7.33 g concentrated sulfuric acid and 61.42 g Oleum 32 (32% SO3 in H2SO4) and 1.95 ml H2O2 (70% in water) is used at a temperature of 50° C. and a methane gas pressure of 100 bar.

The gas phase after the reaction was collected and analysed by GC-MS. The gas phases consists of a mixture of CO and CO2, with only traces of oxygen. Thus, main decomposition products were carbon monoxide and carbon dioxide.

### Example 4

In a 270 ml autoclave, a mixture of 33.52 methanesulfonic acid, 7.21 g concentrated sulfuric acid and 61.57 g Oleum 32 (32% SO₃ in H₂SO₄) and 3.4 ml of H₂O₂ (70% in water) is charged. After a methane pressure is set to 85 bar, the temperature is set to 65° C. Due to an exothermic reaction, the temperature rises to 132° C., while the pressure increases to 110 bar within 1 minute, after that the temperature reaches 65° C. within 5 minutes with a pressure of 99.8 bar. The reaction kept at this temperature for 19.5 h. The reactor was then cooled down to room temperature.

The gas phase after the reaction was collected and analysed by GC-MS. A total of 1.4 vol % oxygen, 0.1 vol % CO and 1.67 vol % CO₂ was detected.

Thus, the main decomposition product was carbon dioxide (as desired); however, a certain amount of oxygen was also found. This example illustrates that temperature control may be used advantageously to achieve optimum results in the inventive method.

1. A method for the decomposition, removal or destruction of at least one peroxo compound, comprising reacting a peroxo compound with an alkane and SO₃.

2. The method according to claim 1, wherein the peroxo compound is selected from the group consisting of inorganic peroxoacids from the group of peroxoacids of boron, silicon, phosphorus, sulfur, nitrogen or carbon, salts of inorganic peroxoacids, hydrogen peroxide and mixtures thereof.

3. The method according to claim 1, wherein the peroxo compound is synthesized by adding H₂O₂ to a compound selected from the group consisting of sulfuric acid, oleum, SO₃, methanesulfonic acid, inorganic oxoacids, salts of inorganic oxoacids, phosphoric acid, salts of phosphoric acid, boric acid, salts of boric acid, and mixtures thereof.

4. The method according to claim 1, wherein mixtures of the peroxo compounds are used.

5. The method according to claim 1, wherein a gas phase ij obtained after the method, and said gas phase contains CO₂ and/or CO.

6. The method according to claim 1, wherein the amount of peroxo compound used is in the range from 0.1 to 4.0 wt % H₂O₂ equivalent.

7. The method according to claim 1, wherein the alkane is methane, ethane, propane or butane.

8. The method according to claim 1, wherein the reaction mixture comprises methanesulfonic acid.

9. The method according to claim 1, wherein the method is performed at a temperature of from 25° C. to 100° C., and/or wherein the method is performed at a pressure of from 10 to 200 bar.

10. The method according to claim 1, wherein the method is a continuous process and the peroxo compound is dosed continuously into the reaction mixture, or wherein the method is carried out as batch process and the peroxo compound is added batchwise to one or more reactors.

11. The method according to claim 1, wherein the method is performed in one or several reactors operated in a cascade of reactors, and/or wherein the reactors used in batch or continuous operation of the method are selected from the group consisting of a continuously stirred tank reactor, an air lift reactor, a bubble column reactor, a trickle bed reactor, a pipe reactor and combinations thereof.

12. The method according to claim 1, wherein SO₃ is added at least in a stoichiometric amount with respect to the peroxo compound to be removed, at the time of dosing.

13. The method according to claim 1, wherein a solution obtained after the reaction may be subjected to a further treatment.

14. The method according to claim 1, wherein the amount of peroxo compound at the beginning of the method is reduced by at least 25%.

15. The method according to claim 1, wherein no additional reducing agents are used in the reaction and at the end of the reaction.

16. The method according to claim 1, wherein the peroxo compound comprises sulfur, phosphor, nitrogen, boron and/or hydrogen peroxide, and the alkane is methane.

17. A method for manufacturing CO2 and/or CO from a peroxo compound, comprising reacting a peroxo compound with an alkane and SO₃.

18. The method for manufacturing CO₂ and/or CO according to claim 17, wherein the amount of peroxo compound used is in the range from 0.1 to 4.0 wt % H₂O₂ equivalent, and/or where-in the method is performed at a temperature of from 25° C. to 100° C., and/or wherein the method is performed at a pressure of from 10 to 200 bar.

19. The method for manufacturing CO₂ and/or CO according to claim 17, wherein the amount of peroxo compound used is in the range from 0.5 to 3 wt % H₂O₂ equivalent.

20. The method for manufacturing CO₂ and/or CO according to claim 17, wherein the reaction mixture contains methanesulfonic acid.

21. The method for manufacturing CO₂ and/or CO according to claim 17, wherein the method is a continuous process and the peroxo compound is dosed continuously into the reaction mixture, or wherein the method is carried out as batch process and the peroxo compound is added batchwise to one or more reactors.

22. The method for manufacturing CO₂ and/or CO according to claim 17, wherein SO₃ is added at least in a stoichiometric amount with respect to the peroxo compound, at the time of dosing.

23. The method for manufacturing CO₂ and/or CO according to claim 17, wherein the reaction mixture is dispersed into small droplets, and/or wherein a fixed bed, Raschig Rings, and/or structured packings are used.

24. The method according to claim 1, wherein the peroxo compound comprises sulfur, phosphor, nitrogen, boron and/or hydrogen peroxide, and the alkane is methane.
